(19) United States
(12) Patent Application Publication
(10) Pub. No.: US 2021/0299753 A1
(43) Pub. Date: Sep. 30, 2021

(54) Method for the Additive Manufacture of a Plurality of Motor Vehicle Components

(71) Applicant: Bayerische Motoren Werke Aktiengesellschaft, Muenchen (DE)

(72) Inventors: Christoph HARTMANN, Muenchen (DE); Benjamin HIMMEL, Muenchen (DE); Philipp LECHNER, Muenchen (DE); Robert RAMAKRISHNAN, Muenchen (DE); Felix SCHUMACHER, Muenchen (DE)

(21) Appl. No.: 17/267,196

(22) PCT Filed: Jul. 30, 2019
(86) PCT No.: PCT/EP2019/070401

§ 371 Date: Feb. 9, 2021

(30) Foreign Application Priority Data
Aug. 24, 2018 (DE) 10 2018 214 310.2

(51) Int. Cl. B22F 10/66; B22F 10/64; B22F 10/62; B33Y 40/20

(52) U.S. Cl. CPC B22F 10/66; B22F 10/64; B33Y 80/00; B33Y 40/20; B22F 10/62

(57) ABSTRACT

A method for additive manufacture of a plurality of motor vehicle components specifies a target geometry for the plurality of motor vehicle components, specifies a production geometry associated with a production position within a tool for additive manufacture according to the specified target geometry, and produces the plurality of motor vehicle components by additive manufacture according to the production geometry in the tool. An actual geometry of the plurality of motor vehicle components associated with a production position is determined, the actual geometry is compared with the target geometry, and the production geometry is adapted according to the comparison.

### BACKGROUND AND SUMMARY OF THE INVENTION

The invention relates to a method for the additive production of a plurality of motor vehicle components.

US 2017/0050271 A1 has disclosed a method for the additive production of a component from a metal matrix composite material for a motor vehicle. In the method, a plurality of elongate filaments and a metal powder are provided. The metal matrix composite material is produced by fusion of the metal powder. In the method, the metal powder is provided in the form of a powder bed, wherein at least a proportion of the elongate filaments is laid on the powder bed for the additive production process. During the additive production process, the metal powder is scanned by means of a scanning device in order to realize fusion of the metal powder, such that at least a proportion of the elongate filaments is fused together in order to hereby selectively fuse the metal powder into a desired shape.

Furthermore, US 2016/0067923 A1 has disclosed a device for additive production. Said device comprises a container in which a bed composed of metal powder can be accommodated. Furthermore, the device comprises a fluidizing device by means of which the metal powder bed can be fluidized. Moreover, the device has, in the container, an articulated mechanism by means of which a component can be held and rotated about at least one horizontal axis. Moreover, the device has an energy-radiating unit by means of which a surface of the metal powder bed can be selectively scanned in order to fuse or sinter the selectively scanned regions of the metal powder bed onto the component.

It is an object of the present invention to create a method for the additive production of a plurality of motor vehicle components, in which method the produced motor vehicle components require only particularly little finish machining.

This object is achieved according to the invention by means of a method for the additive production of a plurality of motor vehicle components, having the features of the independent patent claim. The dependent patent claims and the description relate to advantageous embodiments of the invention.

The invention relates to a method for the additive production of a plurality of motor vehicle components, in which method a setpoint geometry for the plurality of motor vehicle components is predefined. In a manner dependent on the predefined setpoint geometry, a production geometry assigned to a respective production position within a tool for additive manufacturing is predefined. The tool is in particular an additive manufacturing installation.

Furthermore, in the method, the plurality of motor vehicle components is additively manufactured in the tool in a manner dependent on the production geometry. The setpoint geometry for the plurality of motor vehicle components may for example be predefined by means of a CAD model. In particular, the setpoint geometry is predefined for each of the motor vehicle components of the plurality of motor vehicle components, wherein the respective motor vehicle components are manufactured in a manner dependent on the production geometry, wherein the setpoint geometry serves as a shape specification for the respective motor vehicle components. This means that the setpoint geometry is predefined uniformly for each of the motor vehicle components, wherein the respective production geometries of the individual motor vehicle components may vary in a manner dependent on the respective production position of the respective motor vehicle component in the tool. The respective production geometries are derived from the predefined setpoint geometry.

For the respective motor vehicle components, the setpoint geometry is predefined which describes what geometry the motor vehicle components are intended to have after the production thereof. In a manner dependent on the predefined setpoint geometry, a production-position-related production geometry is ascertained for each of the motor vehicle components and is predefined for the production of the plurality of motor vehicle components.

Subsequently, the motor vehicle components are additively manufactured within the tool in a manner dependent on their production geometry assigned to the respective production position. For example, the tool has a container with a bottom plate, wherein the motor vehicle components are manufactured generatively on the bottom plate in respective production positions relative to the bottom plate. Here, in a manner dependent on the respective production position, a distortion of motor vehicle components may occur during the additive manufacturing process for example owing to a temperature of the bottom plate which varies over the bottom plate. In order to compensate for the distortion of the motor vehicle components in a manner dependent on the respective production position, it is provided according to the invention that an actual geometry, assigned to a respective production position, of the plurality of motor vehicle components is ascertained, the actual geometry is compared with the setpoint geometry, and the production geometry is adapted in a manner dependent on the comparison. This means that the respective actual geometry of the motor vehicle components is ascertained for example by means of a detection device.

Furthermore, each of the motor vehicle components is assigned the production position thereof and linked, in an assignment rule, to the actual geometry ascertained for the production position. In the comparison of the respective actual geometry with the setpoint geometry assigned to the respective production position, it is for example the case that a deviation of the actual geometry from the setpoint geometry is ascertained, and the respective production geometry is subsequently adapted in relation to the production position. Consequently, the respective production geometry related to the production position is adapted in a manner dependent on a respective production-related deviation of the actual geometry from the setpoint geometry, in order to keep distortion of the respective additively produced motor vehicle components particularly low at each of the production positions. For the additive production process, it is for example possible for the plurality of motor vehicle components to be additively or generatively manufactured in the course of a selective laser melting process by selective melting of a metal powder.

The described method advantageously permits, by way of the adaptation of the setpoint geometry in a manner dependent on the respective assigned production position, a compensation of production-related and/or tool-related distortion of the motor vehicle component produced at the respective production position. A need for finish machining of the plurality of motor vehicle components can advantageously be kept particularly low by means of the method, because a deviation between the setpoint geometry and the actual geometry can be kept particularly small by means of the method.

In one advantageous refinement of the invention, it is provided that the actual geometry is, after at least one further method step, ascertained in a manner assigned to the respective production position. This means that, after the additive production of the plurality of motor vehicle components within the tool, the plurality of motor vehicle components is machined in the further method step. The respective actual geometry of the plurality of motor vehicle components after the respective at least one method step is checked in the course of the comparison of the actual geometry with the setpoint geometry, and the production geometry is adapted in a manner dependent on the comparison. In this way, in the course of the additive production of the plurality of motor vehicle components, distortion which arises in the at least one further method step and which leads to a deviation of the actual geometry from the setpoint geometry can be compensated, or the distortion can be prevented. This leads to a particularly low need for finish machining of the plurality of motor vehicle components not only in the course of the additive production process but also in the course of the method, in which the plurality of motor vehicle components is both additively produced and also machined in the at least one further method step.

In this context, it has proven to be particularly advantageous if the plurality of motor vehicle components is, in the at least one further method step, heat-treated and/or separated from the tool and/or subjected to mechanical postprocessing and/or chemical postprocessing and/or electrochemical postprocessing. This means that the plurality of motor vehicle components is firstly additively produced in the tool and subsequently heat-treated and thus set to a defined temperature for a defined time interval and/or separated or detached from the tool, in particular from the bottom plate of the tool. Alternatively or in addition, the motor vehicle components may be subjected to mechanical postprocessing and thus blasted, and in this case in particular sand-blasted or corundum-blasted, and/or in particular washed for the removal of contaminants. After the heat treatment and/or separation from the tool and/or mechanical postprocessing such as blasting and/or washing and/or chemical postprocessing and/or electrochemical postprocessing of the plurality of motor vehicle components, the respective actual geometry of the motor vehicle components is ascertained in a manner dependent on the respective production position of the respective motor vehicle component in the tool, and the production geometry is adapted in a manner dependent on the production position. In this way, changes in geometry of the motor vehicle components during the heat treatment and/or separation from the tool and/or mechanical postprocessing such as blasting and/or washing and/or chemical postprocessing and/or electrochemical postprocessing can be taken into consideration already during the additive production of the plurality of motor vehicle components in the course of the adaptation of the production geometry, in order to advantageously keep a need for finish machining of the plurality of motor vehicle components particularly low.

In a further embodiment of the invention, it has proven to be particularly advantageous if the production geometry is adapted in a manner dependent on a raw material of the motor vehicle components. This means that physical and/or chemical characteristics of the raw material are, during the additive manufacturing process and/or during the at least one further method step, ascertained and incorporated into the production-position-related adaptation of the production geometry. It is thus for example possible for flow characteristics and/or melt characteristics of the raw material that are to be expected in the course of the additive production process and/or in the course of the at least one further method step to be ascertained and for the respective production geometries of the motor vehicle components to subsequently be adapted in a production-position-related manner. It is thus also possible, in the case of different raw materials being used, for a respective material-specific distortion of the motor vehicle components to be incorporated into the adaptation of the production-position-related production geometry, for a particularly low need for finish machining of the motor vehicle components.

In a further embodiment of the invention, it has proven to be advantageous for the production geometry to be adapted in a manner dependent on production parameters of the additive manufacturing process. The production parameters may for example be an installation type of the additive manufacturing installation or process variables of the additive manufacturing process such as a production duration or a production temperature of the motor vehicle components or a temperature development in the tool. A respective distortion of the motor vehicle components may change with different production parameters. It is thus particularly advantageous if, in order to avoid a deviation between the setpoint geometry and the actual geometry, the respective production parameters are incorporated in an adaptation of the production geometry.

Further features of the invention will emerge from the claims, from the figures and from the description of the figures. The features and feature combinations mentioned above in the description, and the features and feature combinations mentioned below in the description of the figures and/or only shown in the figures, may be used not only in the respectively specified combination but also in other combinations or individually.

The invention will now be discussed in more detail on the basis of a preferred exemplary embodiment and with reference to the drawings.

### BRIEF DESCRIPTION OF THE DRAWINGS

FIG. 1 is a side view of a tool for additive manufacturing, with a plurality of additively produced motor vehicle components, wherein each of the motor vehicle components is assigned a defined production position; and

FIG. 2 shows a method diagram for a systematic compensation of distortion of the motor vehicle components during the additive production thereof.

### DETAILED DESCRIPTION OF THE DRAWINGS

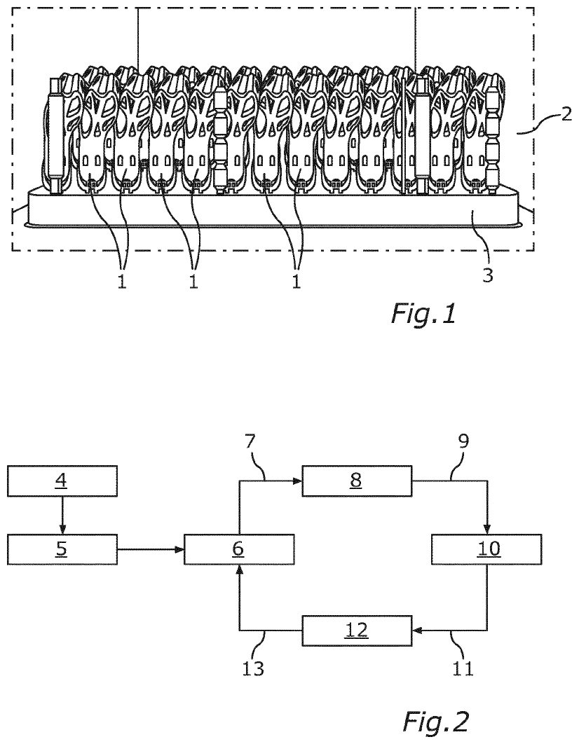

FIG. 1 illustrates a plurality of motor vehicle components 1 which have been produced additively or generatively in a tool 2. In particular, the motor vehicle components 1 have been built up in layers on a bottom plate 3 of the tool 2. For the motor vehicle components 1, a setpoint geometry is predefined which the motor vehicle components 1 are intended to have after the additive manufacturing 7 thereof. During the manufacturing 7 of the motor vehicle components 1, a varying heat distribution may arise in the tool 2 and in particular on the bottom plate 3, which may in turn lead to a distortion of individual motor vehicle components 1.

In order to be able to keep finish machining required as a result of the distortion particularly low, a systematic compensation of the distortion is provided, wherein a method diagram for the systematic compensation is illustrated in FIG. 2. In a first method step 4, the setpoint geometry for the motor vehicle components 1 is predefined. Subsequently, the predefined setpoint geometry is, in a second method step 5, resolved with respect to respective production positions of the motor vehicle components 1 in the tool 2.

In a third method step 6, respective production geometries resolved with respect to production position, which may also be referred to as respective manufacturing geometries, are ascertained for the motor vehicle components 1. Subsequently, the additive manufacturing 7 of the motor vehicle components 1 is performed in the tool 2 in a manner dependent on the respective production position of the motor vehicle components 1 and on the production geometry assigned to the respective production position.

In a fourth method step 8, an actual geometry, assigned to the respective production positions, of the motor vehicle components 1 is ascertained by means of a detection device. Subsequently, in a comparison 9, the respective actual geometry is compared with the setpoint geometry in a production-position-related manner, and in a fifth method step 10, a deviation between the setpoint geometry and the actual geometry is determined. The respective deviation between the setpoint geometry and the actual geometry is assigned to the respective production position in a respective systematic data processing operation 11.

In a sixth method step 12, a compensation of the deviation between the setpoint geometry and the actual geometry is performed. The compensation of the deviation between the setpoint geometry and the actual geometry results in an adaptation 13 of the production geometry in a manner dependent on the compensation. Here, the adaptation 13 of the production geometry is performed in each case in a production-position-related manner. Subsequently, by means of the tool 2, a further plurality of motor vehicle components 1 is additively manufactured in a manner dependent on the adapted production geometries assigned to the production positions.

Alternatively or in addition, the actual geometries of the motor vehicle components 1 can be, after at least one further method step, ascertained and assigned to the respective production position of the respective motor vehicle component 1 during the additive manufacturing 7 thereof in the tool 2. The at least one further method step may be a heat treatment and/or a separation of the respective motor vehicle component 1 from the tool 2 and/or blasting, in particular sand-blasting, and/or washing of the motor vehicle components 1. Here, the respective production geometries may be adapted in a production-position-related manner in a manner dependent on the comparison 9 of the actual geometries after the at least one further method step with the setpoint geometry.

In order to incorporate respective material-specific characteristics, it is possible in the third method step 6 for the respective production geometry of the motor vehicle components 1 to be predefined in a manner dependent on a raw material of the motor vehicle components 1. Alternatively or in addition, the respective production geometry of the motor vehicle components 1 may, in the sixth method step 12, be adapted in a manner dependent on the raw material of the motor vehicle components 1.

It is furthermore possible for the respective production geometry of the motor vehicle components 1 to be adapted in a manner dependent on production parameters of the additive manufacturing process. Here, installation-specific parameters of the tool 2 and/or production-specific parameters of the additive manufacturing process are incorporated in the adaptation of the production geometries.

The described method is based on the recognition that, for automobile production, relatively small metal parts are already produced by additive manufacturing 7. For this purpose, firstly, a CAD model of the metal part to be manufactured is created by computer. For the manufacturing 7, a metal powder is used in a selective laser melting process. The metal powder is applied in layers during the additive manufacturing 7, wherein, in each layer, regions which form the respective metal part are fused in targeted fashion by means of a laser beam.

In the case of production of series parts, that is to say in the case of production of large unit quantities, the metal parts are manufactured closely adjacent to one another on the bottom plate 3, as can be seen in FIG. 1. As a result of the same motor vehicle component 1 being manufactured in large unit quantities directly adjacent to one another, or in a manner nested with one another on the bottom plate 3, which can also be referred to as building plate, a varying heat distribution may arise at different locations on the bottom plate 3. The varying heat distribution may lead to varying stress states in the motor vehicle components 1, which can in turn lead to distortion and thus to low dimensional accuracy. The distortion may be dependent inter alia on a size and/or geometry of the motor vehicle component 1 and/or on a packing density of the motor vehicle component 1 in a structural space of the tool 2 and/or on laser parameters during the additive manufacturing process. Predicting dimensional deviations that arise during the additive manufacturing 7 of the plurality of motor vehicle components 1 by simulation is extremely challenging, and such a prediction is highly dependent on a quality of a respective simulation model that is used, in particular on material and process input variables, and calculation methods used. A topology-optimized design of the respective motor vehicle components 1 may furthermore have the effect that, for a simulation-based prediction, the new material models would have to be generated, which involves high outlay.

The method for distortion compensation as described in conjunction with the figures overcomes these disadvantages. Owing to varying distortion of the respective motor vehicle components 1 on the bottom plate 3, each motor vehicle component 1 is considered in conjunction with its production position. Firstly, the motor vehicle components 1 can be additively manufactured in a manner dependent on the predefined setpoint geometry. Subsequently, the motor vehicle components 1 produced, which may have a respective distortion, can be compared with the setpoint geometry in a spatially resolved manner, that is to say in a production-position-related manner. In a further step, the respective production geometries of each individual motor vehicle component 1 on the bottom plate 3 can be compensated in a location-dependent and thus production-position-related manner. The systematic compensation is repeated until the motor vehicle components 1 that are actually manufactured correspond to the predefined setpoint geometry within defined specified tolerances.

This method is advantageous specifically for production of large unit quantities of motor vehicle components 1. The method leads to particularly fast and particularly straightforward production of the motor vehicle components 1 in the course of the additive production process, whereby production costs can be kept particularly low. During an ongoing series, that is to say in the case of the additive manufacturing of the plurality of motor vehicle components 1 being performed multiple times in succession, it is possible, upon every measurement of the actual geometry, for any process variations that arise to be corrected by virtue of the respective compensation being recalculated. With continuous monitoring of the actual geometry of the motor vehicle components 1, the systematic compensation can be used as a closed-loop geometry controller which ensures constant quality of the motor vehicle components 1 with regard to the dimensional accuracy thereof. Since the systematic compensation is based on the comparison 9 of the actual geometry with the setpoint geometry, dimensional deviations of the further method steps can be taken into consideration in the creation of the respective production-position-related production geometries without increased outlay. Processing times for the geometry-based systematic compensation are particularly short in relation to a physical process simulation.

The described method has the advantage that a respective distortion of the motor vehicle components 1 can be compensated, such that a dimensional deviation of the motor vehicle components 1 with respect to the setpoint geometry can be kept particularly low. Moreover, it is possible to avoid the use of complex mathematical models for predicting the respective distortions of the motor vehicle components 1. The method is moreover a systematic approach which can be applied without prior knowledge. Respective distortion-compensated production of further motor vehicle components 1 with the production-position-related adapted production geometries can be implemented with particularly short development times. With regular measurement of the respective actual geometry of the motor vehicle components 1, the compensation can be used, in an ongoing series, as a closed-loop geometry controller in order to correct process variations such as fluctuations in the raw material and/or ageing or wear of installation equipment, in particular of the tool 2, etc.

### LIST OF REFERENCE DESIGNATIONS

1 Motor vehicle component
2 Tool
3 Bottom plate
4 First method step
5 Second method step
6 Third method step
7 Manufacturing
8 Fourth method step
9 Comparison
10 Fifth method step
11 Systematic data processing
12 Sixth method step
13 Adaptation

1.-5. (canceled)

6. A method for additive production of a plurality of motor vehicle components, comprising:
predefining a setpoint geometry for the plurality of motor vehicle components;
in a manner dependent on the predefined setpoint geometry, predefining a production geometry assigned to a respective production position within a tool for additive manufacturing; and
additively manufacturing the plurality of motor vehicle components in the tool in a manner dependent on the production geometry,
wherein
an actual geometry, assigned to a respective production position, of the plurality of motor vehicle components is determined, the actual geometry is compared with the setpoint geometry, and
the production geometry is adapted in a manner dependent on the comparison.

7. The method according to claim 6, wherein
the actual geometry is, after at least one further method step, determined in a manner assigned to the respective production position.

8. The method according to claim 7, wherein
the plurality of motor vehicle components is, in the at least one further method step, heat-treated, separated from the tool, and/or subjected to mechanical postprocessing, chemical postprocessing r electrochemical postprocessing.

9. The method according to claim 6, wherein
the production geometry is adapted in a manner dependent on a raw material of the motor vehicle components.

10. The method according to claim 6, wherein
the production geometry is adapted in a manner dependent on production parameters of the additive manufacturing process.
